(19) United States
(12) Patent Application Publication
(10) Pub. No.: US 2010/0315395 A1
(43) Pub. Date: Dec. 16, 2010

(54) IMAGE DISPLAY METHOD AND APPARATUS

(75) Inventors: Hwa-Young KANG, Suwon-si (KR); Kang-Hoon Lee, Seongnam-si (KR); Young-Kwon Yoon, Seoul (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/580,805

(22) Filed: Oct. 16, 2009

(30) Foreign Application Priority Data
Jun. 12, 2009 (KR) 10-2009-0052531

(51) Int. Cl. G06F 3/038; G09G 5/10

(52) U.S. Cl. 345/207; 345/690; 345/88

(57) ABSTRACT

Disclosed is an image display method in an image processing apparatus, the method including the steps of: sequentially generating frame images according to each color in rotation in such a manner as to generate one frame image by extracting pixel data corresponding to one color among red (R), green (G), and blue (B) colors from an entire pixel array of an image sensor, the pixel data matching a predetermined resolution; and consecutively displaying the frame images according to each color.

### PRIORITY

This application claims the benefit under 35U.S.C. § 119(a) of a Korean Patent Application filed in the Korean Intellectual Property Office on Jun. 12, 2009 and assigned Serial No. 10-2009-0052531, the disclosures of which are incorporated herein by reference.

### BACKGROUND OF THE INVENTION

1. Field of the Invention

The present invention relates to digital image processing, and more particularly to a method and apparatus for displaying a digital image.

2. Description of the Related Art

As well known in the art, image sensors are semiconductor elements that convert an optical image into an electric signal. Image sensors may be broadly categorized into charge-coupled devices (CCD) and complementary metal oxide semiconductor (CMOS) image sensors.

In a CCD, respective MOS capacitors are very closely located to each other, wherein electric charge carriers are stored in and transferred to the capacitors. A CMOS image sensor is a switching-type device which is provided with pixel arrays using a CMOS integrated-circuit fabrication technology, and sequentially detects outputs thereof. Since the CMOS image sensors have an advantage of low power consumption, the CMOS image sensors can be widely applied to personal portable systems, such as cellular phones.

A CMOS image sensor includes a pixel array with the form of a matrix in which N number of red (R), green (G), and blue (B) pixels are arranged in a row direction, and M number of RGB pixels are arranged in a column direction (wherein N and M are integers). In addition, a Correlated Double Sampling (CDS) section including a plurality of CDS units, each of which is connected to each column, is disposed at a lower side of the pixel array. In addition, the CMOS image sensor includes an analog signal processor (ASP) for processing an analog signal output from the CDS section. The CDS section samples a reset signal and a data signal from each pixel and transfers the sampled reset signal and data signal to the ASP. The ASP calculates a difference between the reset signal and the data signal, and then amplifies the difference. Accordingly, pure pixel data of an actual subject image is obtained.

Also, in order to convert pixel data obtained by the image sensor into an actual image, interpolation is performed to generate RGB values at all pixel positions. That is, an image processing apparatus having an image sensor additionally generates two other colors at each pixel through interpolation.

Specifically, in order to collect one piece of color information per pixel, Bayer RAW data 10 is collected through the use of a color filter, as shown in FIG. 1. In order for an image to have colors on a screen, there should be all ROB data per each pixel, which is achieved through an RGB interpolation. Consequently, when information about one 8-bit color per pixel is collected through interpolation, data level information 20 shown in FIG. 1 is obtained. With respect to each 8-bit pixel, when RGB components are expressed on the pixel through the use of other color information of neighboring pixels, 24-bit information is included after all.

Meanwhile, initially, most image sensors having pixels arranged in an array have a resolution of the CIF level (i.e. about 100 thousand pixels) or a VGA level (i.e. about 300 thousand pixels). The CIF level has an array of about 350×290 pixels in size, and the VGA level has an array of about 650×480 pixels in size. However, recently, products having a MEGA level equal to or more than 10 million pixels have been put on the market.

Most recent applications using MEGA-level image sensors have provided a preview function and/or a sub-sampling function. The sub-sampling function is to extract only one piece of data per N pieces of data in the column and row directions among the entire array data, and generate a new image with a low resolution. For example, when 1/4 sub-sampling is performed on an image with a 100×100 array, an image with a 50×50 array is generated.

Such a sub-sampling function is widely applied to cameras equipped in mobile terminals. That is, in a camera equipped in a mobile terminal, a still picture has a resolution of a MEGA level, but, actually, the front surface LCD has a resolution of a VGA or CIF level, for which the sub-sampling function is used. The reason of using the sub-sampling is that the resolution of an LCD is lower than that of the MEGA level, and an image to be displayed is output in a VGA or 10 CIF level through the use of the sub-sampling function, instead of outputting all the pixel information of the MEGA level, in order to further increase the frame rate of the image.

However, in the sub-sampling process, since the number of selected pixels is less than the total number of pixels in the array of an image sensor, various image-quality degradation phenomena, including a staircase phenomenon in layout, a noise such as deterioration, a distortion in color, etc. may occur. Moreover, even when a preview screen is provided through sub-sampling, the image sensor performs an interpolation operation, so that a time delay equal to the period of the interpolation operation may occur.

### SUMMARY OF THE INVENTION

Accordingly, the present invention has been made to solve the above-mentioned problems occurring in the prior art, and the present invention provides a method and apparatus for displaying an image with an excellent image quality.

Also, the present invention provides a method and apparatus for generating and displaying an image at an increased speed.

In accordance with an aspect of the present invention, there is provided a method for displaying an image by an image processing apparatus, the method including the steps of: sequentially generating frame images according to each color in rotation in such a manner as to generate one frame image by extracting pixel data corresponding to one color among red (R), green (G), and blue (B) colors from an entire pixel array of an image sensor, the pixel data matching a predetermined resolution; and consecutively displaying the frame images according to each color.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view explaining the conventional image generating method;

FIG. 2 is a block diagram illustrating the configuration of an image processing apparatus according to an exemplary embodiment of the present invention;

FIG. 3 is a block diagram illustrating the configuration of an image sensor according to an exemplary embodiment of the present invention;

FIG. 4 is a flowchart illustrating an operation procedure of the image processing apparatus according to an exemplary embodiment of the present invention; and

FIG. 5 is a view illustrating the display of frame images according to an exemplary embodiment of the present invention.

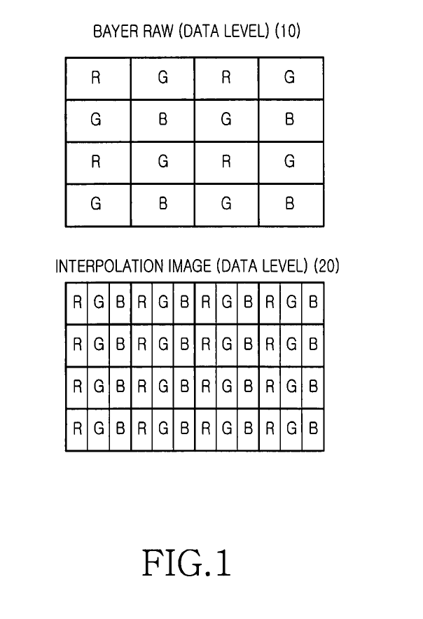

### DETAILED DESCRIPTION OF THE EXEMPLARY EMBODIMENT

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

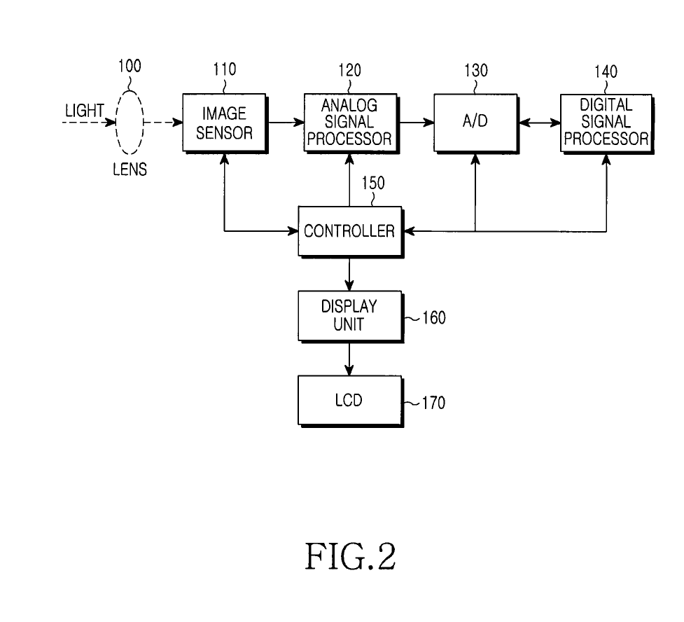

First, the configuration of an image processing apparatus, to which the present invention is applied, will be described with reference to FIG. 2. Referring to FIG. 2, the image processing apparatus includes a lens 100, an image sensor 110, an analog signal processor 120, an analog-to-digital converter 130, a digital signal processor 140, a controller 150, a display unit 160, and an image display 170.

Light from an object scene is focused by the lens 100 to form an image on the solid-state image sensor 110. The image sensor 110 selects pixels in a pixel array according to the control of the controller 150, converts incident light into an electric signal with respect to the selected pixels, and outputs the electric signal to the analog signal processor 120. According to an embodiment of the present invention, the image sensor 110 may be a charge-coupled device (CCD) type or an active pixel sensor (APS) type (APS devices are often referred to as CMOS sensors because of the ability to fabricate the APS devices in a Complementary Metal Oxide Semiconductor Process).

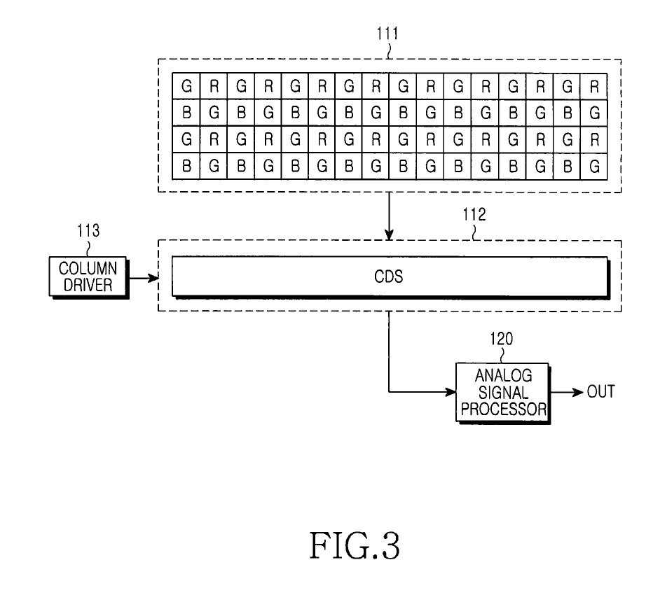

An example of the image sensor 110 is shown in FIG. 3. Referring to FIG. 3, the image sensor 110 includes a pixel array 111, a Correlated Double Sampling (CDS) section 112, and a column driver 113.

The pixel array 111 of the image sensor 110 has the form of a matrix in which N number of red (R), green (G), and blue (B) pixels are arranged in a row direction, and M number of RGB pixels are arranged in a column direction (wherein N and M are integers). The CDS section 112 includes CDS units according to each column, and is disposed at a lower side of the pixel array 111. The CDS section 112 samples a reset signal and a data signal from each pixel and outputs the sampled reset signal and data signal to the analog signal processor 120.

Referring again to FIG. 2, the analog signal processor 120 processes analog signals by calculating a difference value between the reset signal and the data signal and amplifying the difference value, and outputs the resultant value to the analog-to-digital converter 130.

The controller 150 generates various clock signals to select rows and pixels in the pixel array of the image sensor 110, and synchronizes the operation of the analog signal processor 120 with the operation of the analog-to-digital converter 130.

A final stream of digital pixel values from the analog-to-digital converter 130 is stored in a memory (not shown) associated with the digital signal processor 140.

The digital signal processor 140 generates a final image by processing digital signals, and outputs the generated image to the controller 150.

The controller 150 controls the overall operation of the image processing apparatus based on a software program stored in a program memory, which may include a Flash EEPROM or another nonvolatile memory. The memory is used to store image sensor calibration data, selections set by the user, and other data which must be preserved when the image processing apparatus is turned off.

The controller 150 controls the image sensor 110 by generating clocks to operate elements associated with the image sensor 110, and instructs the digital signal processor 140 to process collected pixel data, thereby controlling the sequence of image capture.

Processed images are copied to a display buffer in a system memory under the control of the controller 150, and consecutively read out through the display unit 160 to produce a video signal. This signal is processed by the display unit 160 so as to be displayed on an external monitor, and is presented on the image display 170. The image display 170 is typically a liquid crystal display (LCD), and other types of displays may be used as well.

According to another embodiment of the present invention, the digital signal processor 140 may be included in the controller 150.

Generally, in order to generate and display an image, the image processing apparatus performs an interpolation to obtain RGB values at all pixel positions of the pixel array 111.

The image sensor 110 collects original data (Bayer RAW data) by means of a color filter in order to collect one piece of color information per pixel. In the case of generating an image having a resolution of 640×480 pixels, the image sensor 110 collects G-component pixel data of 320×240 pixels, R-component pixel data of 160×120 pixels, and B-component pixel data of 160×120 pixels from the entire pixel array 111.

Then, the controller 150 performs an interpolation for the pixel data of the entire 640×480 pixels through the digital signal processor 140, and finally generates and displays one frame image having RGB components according to each pixel.

However, according to the present invention, when displaying an image with a predetermined resolution, the controller does not perform an interpolation for each pixel, but displays an image through the use of original data collected by the image sensor 110. To this end, the image sensor 110 extracts color-based pixel data according to the resolutions of images to be displayed from the entire pixel array 111, and the controller 150 performs a control operation to generate separate frame images formed on a color-by-color basis, without an interpolation.

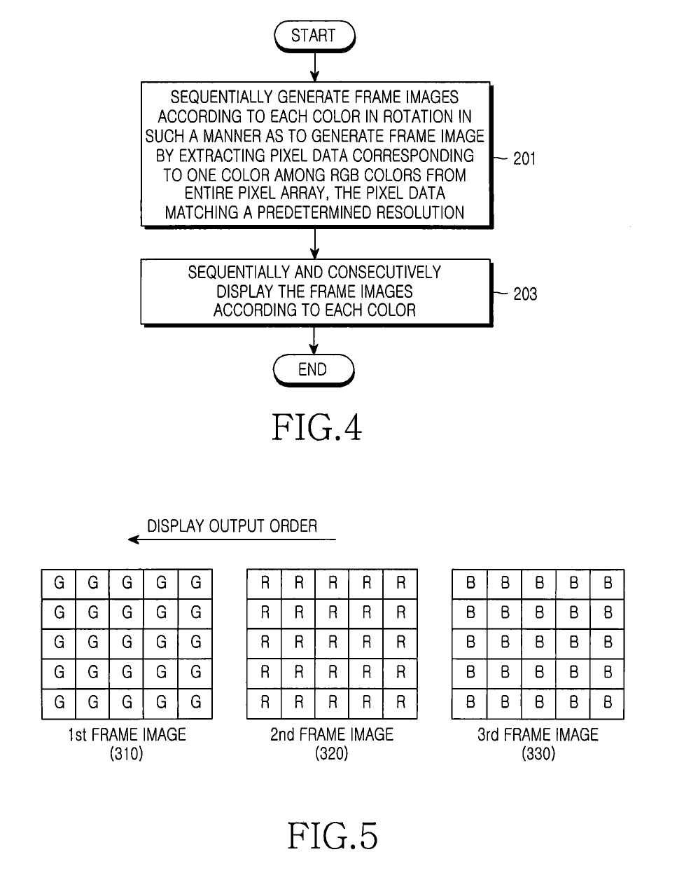

In other words, the controller 150 extracts pixel data corresponding to only one color of RGB color matching a predetermined resolution, and generates one frame image. In such a manner, the controller 150 sequentially generates frame images according to each color in rotation (step 201 in FIG. 4).

Then, the controller 150 sequentially and rapidly displays the frame images according to each color so that the user can feel that an image of normal color is displayed based on the color afterimage effect and the optical illusion effect (step 203).

When an image with a resolution of 640×480 is to be displayed, as described in the above example, the image sensor 110 extracts pixel data of G color pixels corresponding to the resolution of 640×480 from the entire pixel array 111, and outputs the extracted pixel data to the analog signal processor 120.

Then, the analog signal processor 120, analog-to-digital converter 130, and digital signal processor 140 process the output pixel data in regular sequence, thereby generating a first frame image 310 formed with only G color, as shown in FIG. 5.

Next, the image sensor 110 extracts pixel data of R color pixels corresponding to the resolution of 640×480 from the entire pixel array 111, and outputs the extracted pixel data to the analog signal processor 120. Then, the analog signal processor 120, analog-to-digital converter 130, and digital signal processor 140 process the output pixel data in regular sequence, thereby generating a second frame image 320 formed with only R color. Next, through the same process, a third frame image 330 formed with only B color is generated.

The three frame images 310, 320, and 330 generated in such a manner are sequentially and consecutively output to the display unit 160 according to the control of the controller 150, and are displayed on the image display 170. In this case, although a display duration time period per frame image is set to such a short time that it cannot be perceived by human eyes, human eyes recognize the frame images as if one frame image with normal color is displayed due to the color afterimage effect and the optical illusion effect upon human eyes.

According to the apparatus and method of the present invention, it is possible to display an image with better image quality than that in the conventional display method. This is because the total number of pixels used to generate an image in the conventional display method corresponds to a predetermined resolution, but the apparatus and method according to the present invention uses three times the pixels corresponding to the predetermined resolution. In addition, since the apparatus and method according to the present invention performs no interpolation, it is possible to effectively prevent color from being distorted.

Especially, in the preview mode, the conventional method must generate an image according to a resolution supported by an LCD of an image processing apparatus, so that there is a high likelihood that color distortion or image quality degradation occurs. However, when the apparatus and method according to the present invention is applied, it is possible to display an image with better image quality than that in the conventional method. That is, according to the present invention, the R, G, and B frame images are individually generated and consecutively displayed, based on the maximum resolution which is supported by the LCD of the image processing apparatus, so that it is possible to provide a high definition preview.

According to the present invention, even when an image is generated and displayed in a resolution lower than a resolution which can be captured by the image sensor, it is possible to display an image with good image quality, and also to display the image at an increased speed.

While the invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for displaying an image by an image processing apparatus, the method comprising the steps of:
sequentially generating frame images according to each color in rotation in such a manner as to generate one frame image by extracting pixel data corresponding to one color among red (R), green (G), and blue (B) colors from an entire pixel array of an image sensor, the pixel data matching a predetermined resolution; and
consecutively displaying the frame images according to each color.

2. The method as claimed in claim 1, wherein the generating step comprises the steps of:
extracting pixel data corresponding to R color matching the predetermined resolution from the entire pixel array of the image sensor, and generating a first frame image of the R color;
extracting pixel data corresponding to G color matching the predetermined resolution from the entire pixel array, and generating a second frame image of the G color; and
extracting pixel data corresponding to B color matching the predetermined resolution from the entire pixel array, and generating a third frame image of the B color.

3. The method as claimed in claim 2, wherein, in the displaying step, the first frame image, the second frame image, and the third frame image are consecutively displayed.

4. The method as claimed in claim 3, wherein the pixel array has a form of a matrix in which N number of RGB pixels are arranged in a row direction, and M number of RGB pixels are arranged in a column direction, wherein N and M are integers.

5. The method as claimed in claim 4, wherein the predetermined resolution corresponds to a maximum resolution supported by a display unit included in the image processing apparatus.

6. An image display apparatus comprising:
an image sensor;
a controller for controlling the image sensor, and sequentially generating frame images according to each color in rotation in such a manner as to generate one frame image by extracting pixel data corresponding to one color among red (R), green (G), and blue (B) colors from an entire pixel array of an image sensor, the pixel data matching a predetermined resolution; and
a display unit for consecutively displaying the frame images according to each color according to control of the controller.

7. The apparatus as claimed in claim 6, wherein the controller extracts pixel data corresponding to R color matching the predetermined resolution from the entire pixel array of the image sensor, and generates a first frame image of the R color;
extracts pixel data corresponding to G color matching the predetermined resolution from the entire pixel array, and generates a second frame image of the G color; and
extracts pixel data corresponding to B color matching the predetermined resolution from the entire pixel array, and generates a third frame image of the B color.

8. The apparatus as claimed in claim 7, wherein the display unit consecutively displays the first frame image, the second frame image, and the third frame image according to control of the controller.

9. The apparatus as claimed in claim 8, wherein the pixel array has a form of a matrix in which N number of RGB pixels are arranged in a row direction, and M number of RGB pixels are arranged in a column direction, wherein N and M are integers.

10. The apparatus as claimed in claim 9, wherein the predetermined resolution corresponds to a maximum resolution supported by a liquid crystal display (LCD) included in the display unit.
